(19) United States
(12) Patent Application Publication
(10) Pub. No.: US 2024/0317397 A1
(43) Pub. Date: Sep. 26, 2024

(54) PARACHUTE RANGE AUGMENTER

(71) Applicant: Rhea Higher Education and Aviation LLC, Tiburon, CA (US)

(72) Inventors: David Michael Rhea, Eloy, AZ (US); Benjamin Michael Fox, Campbell, CA (US)

(21) Appl. No.: 18/609,402

(22) Filed: Mar. 19, 2024

Related U.S. Application Data
(60) Provisional application No. 63/453,360, filed on Mar. 20, 2023.

(51) Int. Cl. B64C 39/02; B64D 17/62; B64D 31/04

(52) U.S. Cl. CPC B64C 39/026; B64D 17/62; B64D 31/04

(57) ABSTRACT

A device includes a harness system configured to be attached to a parachute harness of a parachute. The device also includes a propulsion system connected to the harness system, wherein the propulsion system is configured to be off when undeployed and during freefall, and wherein the propulsion system is configured to deploy during canopy flight stage to generate thrust for a parachutist of the parachute. The device further includes a circuitry configured to control power generation by the propulsion system to control the thrust. The device includes a power source configured to power the circuitry and the propulsion system.

### RELATED APPLICATIONS

The instant application is a Non-Provisional Patent Application that claims the benefit and priority to the U.S. Provisional Application No. 63/453,360, filed on Mar. 20, 2023, which is incorporated herein by reference in its entirety.

### BACKGROUND

Parachutes used for jumping are limited in their lateral range. For example, the maximum lateral distance achievable under conventional parachute jumping is a factor of the altitude and the relative speed. Conventionally, in the nonlimiting example of military applications, military personnel may be equipped with a dual parachute system with ram air canopies attach that are needed for both freefall and for military operations on the ground. Generally, when exiting an aircraft, the equipment is attached to the jumper or to his/her parachute harness. Once the parachute is deployed, the jumper transitions from freefall position to a suspended mode under an airfoil with the equipment being fastened securely to handle the transition from freefall to canopy flight. The parachute uses gravity to convert airflow to lift. It is appreciated that the angle of the wing uses gravity to increase velocity of airflow into the canopy, which can be used to fly the airfoil to a particular location given airspeed across the wing matches the required amount of sustained lift, thereby reducing the decent rate and speed. The parachute system trends in a downward angle until the required airspeed is needed.

In certain applications, e.g., military applications, a longer range may be desired but is not available via the parachute system described above. Other devices may be used with a longer range, e.g., gliders (with motor or without). However, gliders cannot be used in freefall applications such as a jumper with a parachute system. Moreover, in a military application the jumper may be under attack and not being under freefall puts the military personnel at a higher risk of being target.

### SUMMARY

Accordingly, a need has arisen to increase the range (lateral range) of a jumper when in a freefall and/or canopy flight position. In some embodiments, a propulsion device that is a detachable device is disclosed. The propulsion device attaches to a parachute via a harness. It is appreciated that the propulsion device may include a power source, e.g., one or more batteries, to power a propulsion mechanism, e.g., one or more electric fan motors, that generates thrust for the jumper once the jumper engages the detachable device. It is appreciated that in an unengaged mode (i.e., inactive) during freefall, the propulsion device has minimal interference with the freefall operation of the parachute, if any. Once a jumper deploys the parachute to transition from the freefall position to a canopy flight position, the propulsion device may be engaged to move from its unengaged mode to an engaged mode. In some embodiments, the propulsion mechanism is mechanically moved to a different position and the power source powers the one or more electric fan motors to generate thrust and increase the range.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a freefall parachutist with a parachute according to one aspect of the present embodiments.

FIG. 2A depicts an example of a propulsion device in an undeployed position according to one aspect of the present embodiments.

FIG. 2B depicts an example of a propulsion device in a deployed position according to one aspect of the present embodiments.

FIGS. 3A and 3B depict an example of a parachute in an undeployed position according to one aspect of the present embodiments.

FIG. 4 depicts an example of a freefall parachutist with a parachute deployed during canopy descent according to one aspect of the present embodiments.

FIGS. 5A and 5B depict an example of a freefall parachutist equipped with a parachute and a propulsion device in an undeployed position during freefall according to one aspect of the present embodiments.

### DETAILED DESCRIPTION

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Before various embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein. It should also be understood that the terminology used herein is for the purpose of describing the certain concepts, and the terminology is not intended to be limiting. Unless defined otherwise, all technical and scientific terms used herein have the same meaning as commonly understood in the art to which the embodiments pertain.

As described above, there is a need to extend the lateral range of a freefall parachutist with minimal interference during the freefall stage of skydiving. It is appreciated that a propulsion device including a propulsion mechanism is proposed that attaches to a conventional parachute at one or more points using one or more attachment mechanisms, e.g., harness. In some embodiments, the detachable system attaches to the chest area of the freefall parachutist (mirroring attachment of the parachute to the back but instead to the front of the freefall parachutist). Accordingly, during freefall stage of the operation there is minimal drag attributed to the device since it is position on the chest of the freefall parachutist. It is, however, appreciated that the propulsion device may be attached to the parachute proximate to the waist area such that the propulsion device is positioned between the freefall parachutist's legs during freefall.

According to some embodiments, regardless of the manner by which the propulsion device is attached to the parachute, once deployed to engage after freefall and during the canopy flight stage, increases the glide ratio, thereby extends the lateral distance that the freefall parachutist can achieve. It is appreciated that the propulsion device may be engaged at any altitude and generate a variable thrust (e.g., based on the power generated by the propulsion mechanism) (which may be programmed prior to deployment or controlled during skydiving) to increase or decrease the lateral distance of the freefall parachutist. In some embodiments, the propulsion device may be programmed to provide a preprogrammed lateral distance to the freefall parachutist once deployed at a given altitude. In yet other examples, the propulsion device may be controlled by the freefall parachutist during the jump to provide the necessary/desired lateral distance.

It is appreciated that in some optional embodiments, the propulsion device may be returned to its configuration prior to being deployed, for landing in order to reduce interference with the freefall parachutist landing operation. Moreover, it is appreciated that the propulsion mechanism such as electric fan motors increase the horizontal speed of the jumper once in canopy flight stage, thereby adding thrust and/or increasing airspeed with a relative flat angle to reduce decent rate to zero.

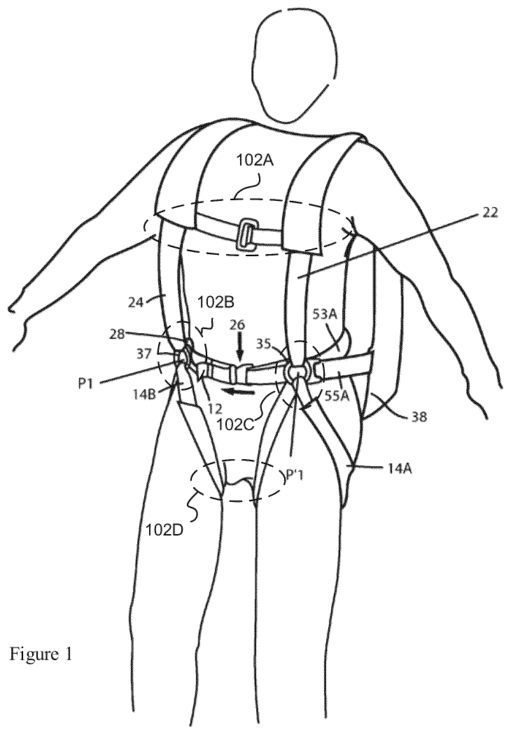

FIG. 1 depicts an example of a freefall parachutist with a parachute according to one aspect of the present embodiments. A freefall parachutist may be equipped with a harness that carries the main parachute wrapped in a back container 38. The harness is in a vertical first position where the support of the harness on the back is adapted to the free-fall operations and to the deployment phase. It is appreciated that the waist belt 12 is adjustable after locking by the tightening means.

In some embodiments, the locking element comprises a retaining buckle 26 which is made up of half buckles 25 and 27 (shown in FIG. 4) assembled together and which can be detached as required, and the tightening means is associated to the half buckle 25. The loop located on each side of the represented harness is associated to a C-shaped connecting rings 35, 37 dedicated to the sliding of the side fastening strap segments 55A and 55B and of the side transverse strap segments 53A and 53B. The lengths of strap segments are disposed into a closed loop and are integral with one another when the locking element 26 is closed.

In some embodiments, the leg straps 14A and 14B are firmly fixed by one end to their respective connecting ring equipped with the loop 35, 37. It is appreciated that the lower ends of the left and right main straps 22, 24 are fixed to a fastening point (P1, P1) by their respective connecting ring equipped with the loop 35, 37.

In some embodiments, the retaining half buckle 27 is adapted to freely move on the left segments of the side transverse strap 53A and of the side fastening strap 55A, before the complete tightening of the waistbelt 12. It is appreciated that the length of the waist belt 12 is adjustable after assembly of the link element represented by the bolt carried by the double loop coupled to the member 25, with the keeper of the other half buckle 27 forming the retaining buckle 26.

In some embodiments, the side transverse strap segments 53A, 53B are moved closer and adjusted by self-tightening of the waistbelt 12. The waist belt 12 is tightened depending on the user's size to obtain an adjustment adapted to the user's size, so that the side transverse strap segments 53A and 53B conform to the body shape between the retaining buckle 26 and the wearer's back.

In some embodiments, the adjustment obtained remains unchanged during the whole free-fall phase by automatically blocking the retaining buckle 26, until a manual intervention loosens or suppresses the supporting effort exerted by the retaining buckle 26.

In some embodiments, releasing the retaining buckle 26 is achieved by the manual separation of the bolt and of the keeper. After having pulled on the leg straps 14A and 14B and put the parachute on the back as a jacket or a harness, the user positions the waist belt 12 by engaging the bolt coupled to the double loop belonging to the member 25 in the keeper of the half buckle 27, and pulls, with one hand, the end of the waistbelt 12 in the direction of the arrow shown in FIG. 1.

The configuration described above enables to jointly exert an adjustment of the side transverse strap segments 53A and 53B around one's body, for more comfort while providing a tension of the side fastening straps 55A and 55B ensuring the support of the back container 38 on the wearer's back.

A consequence is that the gradual movement of tightening of the length of the waist belt 12 between the tensioning means represented by the loop 28 and the retaining buckle 26 is associated to the fact that the left segments of side transverse strap 53A and of side fastening strap 55A simultaneously get closer to their respective opposed segments 53B and 55B.

In some embodiments, the retaining buckle 26 blocks the waist belt 12 in the desired tightening position. Once the adjustment of the waist belt 12 is complete, the user can jump because the support of the back container 38 on the freefall parachutist's back is ensured during free-fall due to the joint and simultaneous tightening of the side transverse strap segments 53A, 53B and of the side fastening strap segments 55A and 55B.

In the example of FIG. 1, various harness attachment points 102A, 102B, 102C, and/or 102D are added to connect the propulsion device according to some embodiments. It is appreciated that attachment points 102A, 102B, and/or 102C provides for connecting the propulsion device to the chest area of the freefall parachutist, thus reducing potential interference during the freefall stage of the skydive. In some nonlimiting examples, the propulsion device may be attached to the connection point 102D and as such be positioned between the freefall parachutist's legs during freefall.

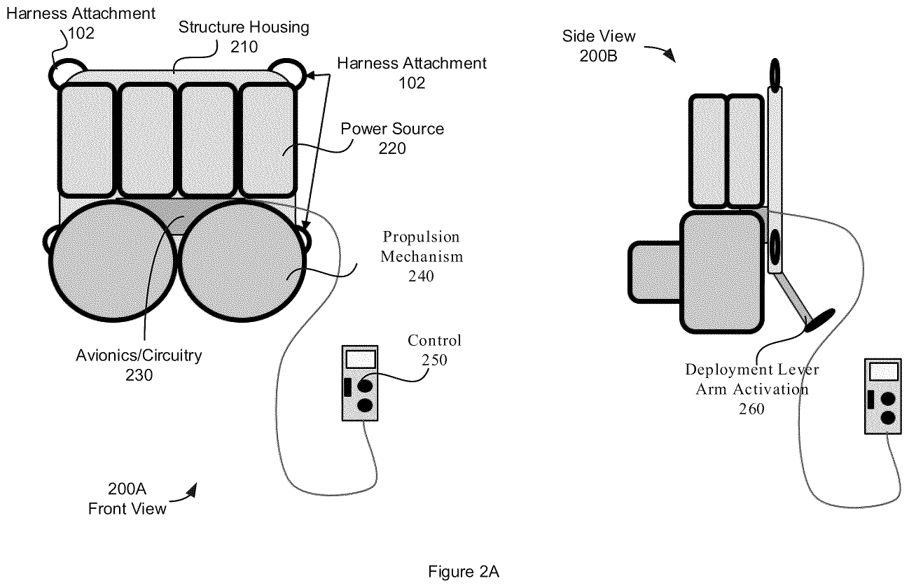

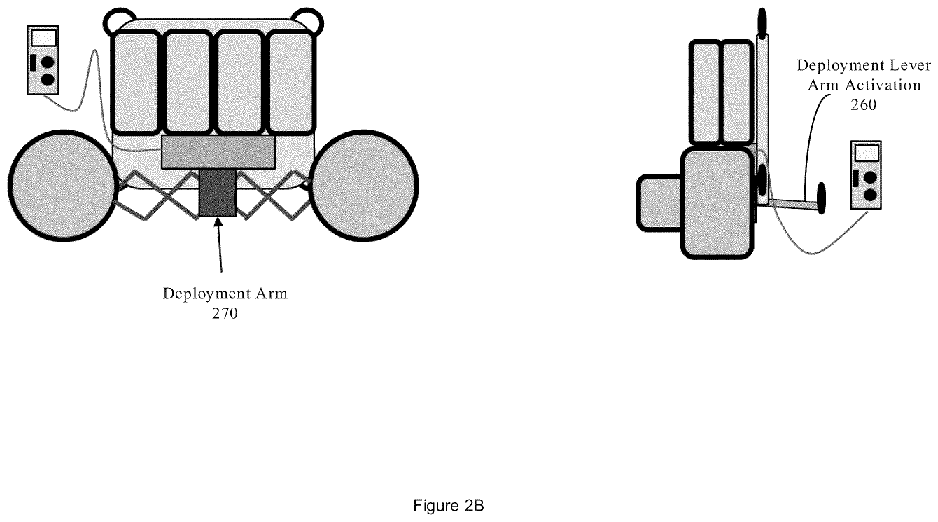

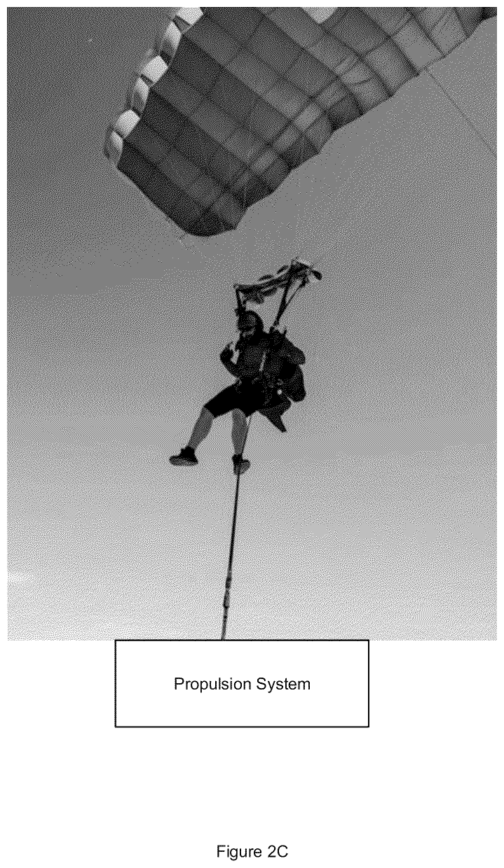

FIG. 2A depicts an example of a propulsion device in an undeployed position according to one aspect of the present embodiments. A front view 200A and side view 200B of the propulsion device is shown. The propulsion device may include a structure housing 210, a power source 220, an avionic/circuitry 230, a propulsion mechanism 240, and a control 250.

In some embodiments, the structure housing 210 is a structure where other components of the propulsion device is assembled on one side. It is appreciated that the other side of the structure housing 210 (the side that is free of components) may be the side that abuts the freefall parachutist's chest in a chest configuration. The power source 220 may be one or more batteries that are housed on the structure housing 210. The power source 220 provides power to the avionic/circuitry 230 (also housed on the structure housing 210) that controls the operations of the propulsion mechanism 240 (also positioned on the structure housing 210).

In some embodiments, the avionic/circuitry 230 may be a control system that controls the power provided by the propulsion mechanism 240, thereby controlling the lateral distance. In some embodiments, the avionic/circuitry 230 may include a memory component (e.g., random access memory (RAM), static random access memory (SRAM), flash, solid state drive, etc.) and a processor (e.g., central processing unit (CPU), an application specific integrated circuit (ASIC), a field programmable gate array (FPGA), etc.). A program that controls the operation of the propulsion mechanism 240 can be stored in the memory component and processed by the avionic/circuitry 230 processor. The programming may be performed prior to the jump, e.g., power generated by the propulsion mechanism 240 may be programmed, such that once deployed at a given altitude it provides a certain lateral distance. It is, however, appreciated that operation of the propulsion mechanism 240 may be overwritten by the diver, as desired during skydiving, e.g., using the control 250. It is also appreciated that in some embodiments, no preprogramming may be necessary and the thrust generated may be controlled by the freefall parachutist during jump using the control 250.

It is appreciated that in one nonlimiting example, the propulsion mechanism 240 may be one or more fan electric motors. The avionic/circuitry 230 and/or control 250 may control the speed by which the fan electric motors operate once deployed, thereby controlling the lateral distance of the jumper. In some embodiments, the propulsion mechanism 240 may be symmetrical, e.g., having a right portion and a left portion, such that increase power on one would enable the diver to make turns (e.g., left turn or right turn) during the canopy flight. It is appreciated that the same speed for the left and the right portion enables the jumper to move forward in a straight path (assuming no wind).

It is further appreciated that the propulsion device may also include one or more harness attachments 102 points to enable attachment to the parachute.

In some embodiments, the side view 200B shows the deployment lever arm 260 according to some embodiments. The deployment lever arm activation 260 when in a first position (e.g., undeployed position) enables the diver to freefall with minimal interference from the propulsion device. Once the deployment lever arm activation 260 is moved to a second position (e.g., deployed position), then the propulsion mechanism 240 is moved into a deployed positioned via a deployment arm 270, as shown in FIG. 2B. The deployment arm 270 may be a folding arm that extends out when in the deployed position and contracts when in unengaged position. The propulsion mechanism 240 in a deployed position extends to the sides of the diver (to the left and the right side of the freefall parachutist's body) to enable the propulsion mechanism 240 to generate thrust, thereby extending the lateral distance. It is appreciated that the deployment arm 270 may be a folding arm, as illustrated, that is mechanically controlled. However, in some embodiments, the deployment arm 270 may be electronically controlled (e.g., soft button on the control 250) and instead of using the deployment lever arm activation 260.

It is further appreciated that control 250 is shown as wired to the avionic/circuitry 230 for illustrative purposes only and should not be construed as limiting the scope of the embodiments. For example, the control 250 may be communicatively coupled to the avionic/circuitry 230 via wireless signal, e.g., Bluetooth.

It is appreciated that the propulsion device may be attached to the parachute via an independent harness or attached to an existing harness worn by the freefall parachutist, via multiple release points. As described above, the propulsion device may be adjusted to be attached at various locations including lower attachment points for rear/seat mount or front attachment (i.e., chest mount). According to some embodiments, the propulsion device may be jettisoned using single point release in case of an emergency with a single point cutaway. It is appreciated that the modular recovery/lowering system to allow for full jettison, jettisoning the lowering line, or jettison to dedicate parachute based on user need. It is appreciated that the propulsion system in jettisoning lowered line is shown in FIG. 2C for illustration purposes only.

It is appreciated that according to some embodiments, the propulsion device may be stowed away (returned to its unengaged configuration), as shown in FIG. 2A, during canopy flight and for landing. As such, any interference with landing is reduced.

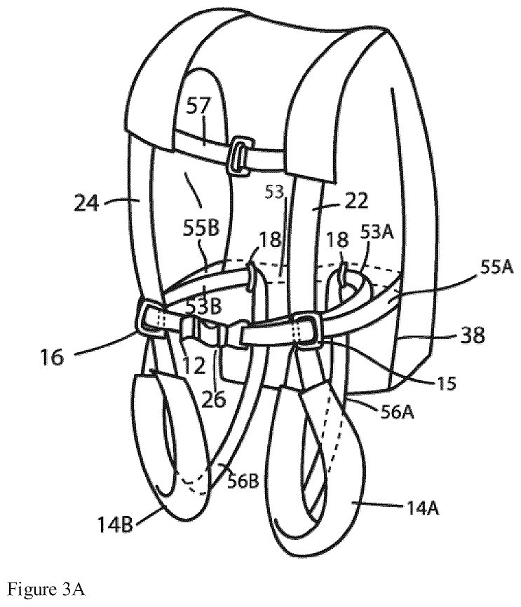

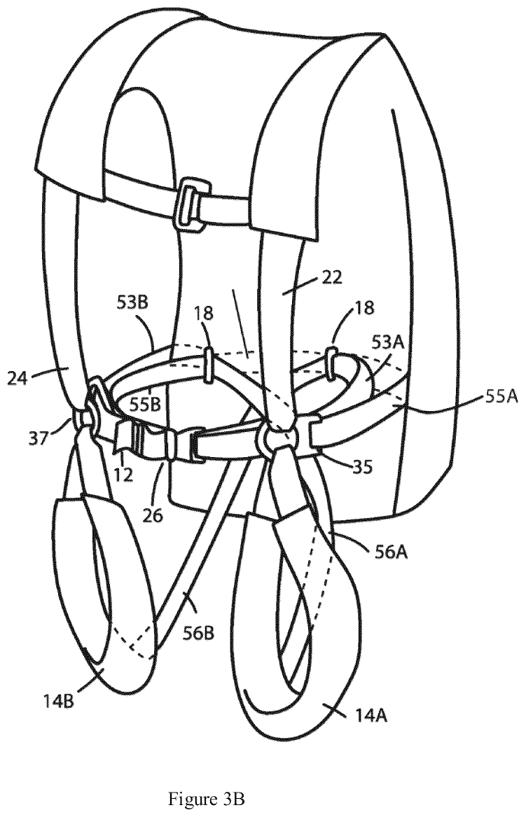

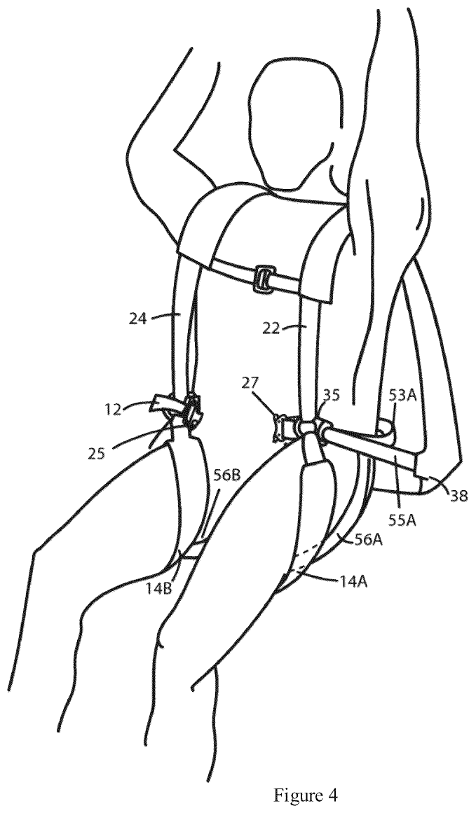

FIGS. 3A and 3B depict an example of a parachute in an undeployed position (without the propulsion device attached). Referring to FIG. 3A, in the absence of connecting rings provided with the loop 35, 37, the ends of leg straps 14A and 14B are fixed in the extension of the lower end of the main straps 22, 24. The loop which ensures the sliding of the strap segments consists of the rectangular rings 15 and 16 disposed at the periphery of the main straps 22, 24, instead of the connecting rings provided with the loop 35, 37.

In some embodiments, the positioning of the chest strap 57 is for illustrative purposes only and should not be construed as limiting the scope of the embodiments. The side transverse strap segments 53A, 53B extend without interruption between the buckle 26 and the loop 18 intended to link them to the back transverse strap 53 and to delineate them from the saddle straps 56A, 56B whereas the side fastening strap segments 55A, 55B extend between the buckle 26 and the container 38 after a passage in the loops 15 and 16. Both right and left segments of side fastening straps 55A, 55B are connected to the periphery of the back container 38 but could be attached further inside the container.

As illustrated in FIG. 3A, both saddle straps 56A and 56B are connected by one end to the leg straps 14A and 14B and become by extension of the other end, the side transverse strap segments 53A and 53B after their passage for each one in a loop 18 allowing a change in angle of 90° in its path for illustrative purposes but should not be construed as limiting the scope of the embodiments. For example, in some embodiments they can link the leg straps 14A and 14B to the back straps, through the backrest of the container 38.

In some embodiments, the tensile stress exerted by the waist belt 12, uniformly shares out on each side of the user and remains maintained as long as the locking of the buckle 26 is done or as long as the waist belt 12 will not have been manually loosened.

In the example of FIG. 3B, the saddle straps 56A, 56B are crossed and their ends which are not connected to the leg straps become by extension the segments of the opposed side transverse strap 53B, 53A after their passage in the loop 18. Accordingly, in FIGS. 3A and 3B, a freefall parachutist tightening the waist belt 12, simultaneously tightens the excess of saddle straps 56A, 56B. During the canopy descent, the unlocking of the waist belt 12 enables the loosening of the saddle straps 56A, 56B and the possibility to seat for the user.

FIG. 4 depicts an example of a freefall parachutist with a parachute deployed during canopy descent (the propulsion device is not illustrated). Once the canopy descent is initiated, the simple manual unlocking of the retaining buckle 26 allows the wearer to take place in a seated position.

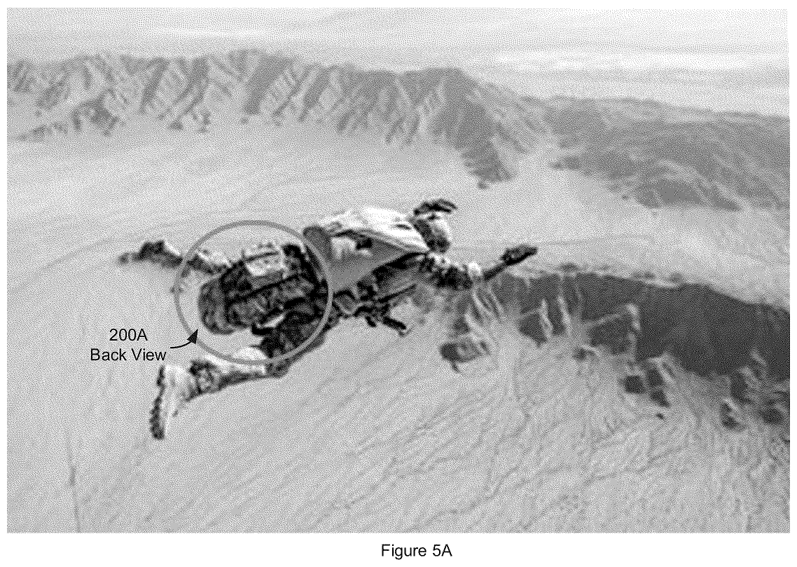

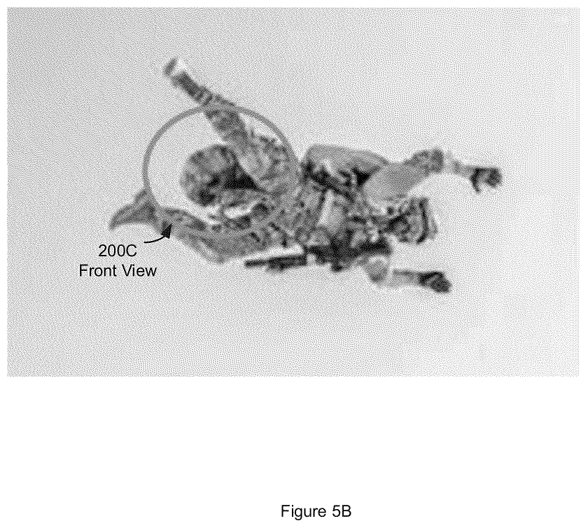

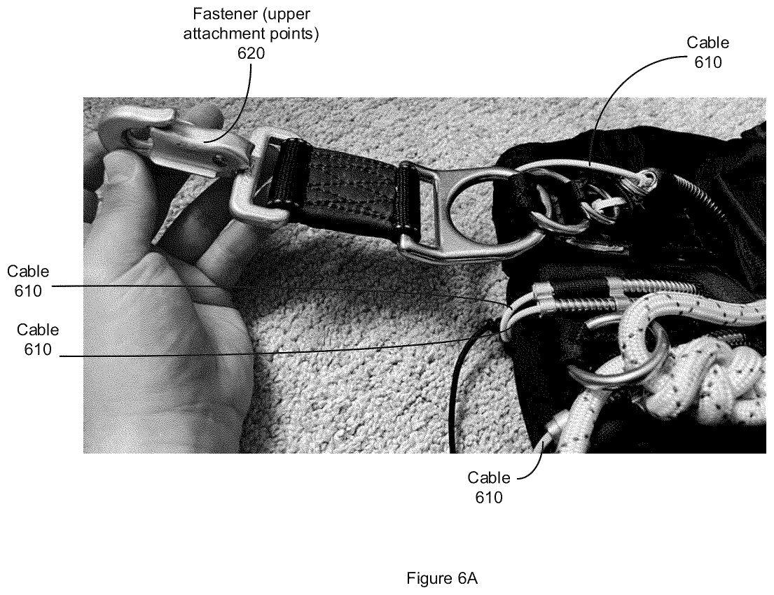

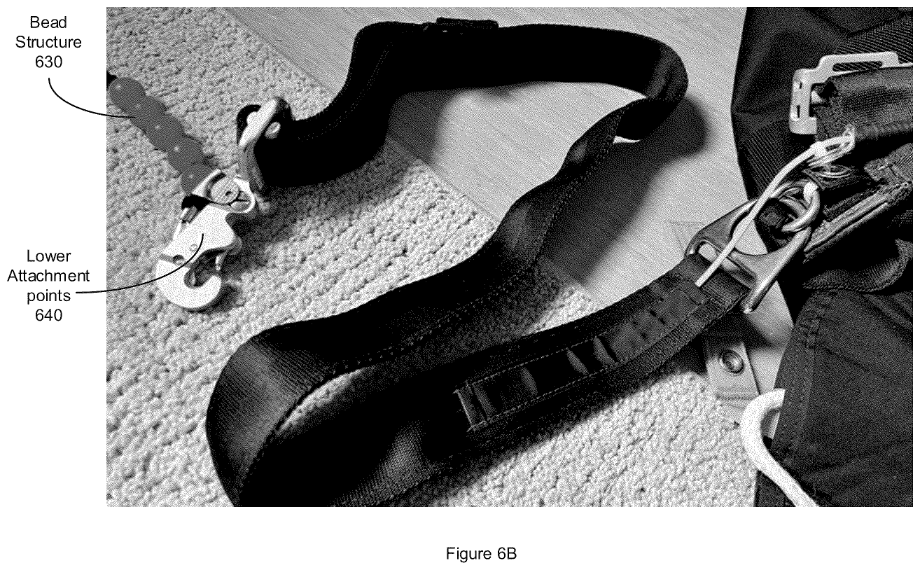

FIGS. 5A and 5B depict an example of a freefall parachutist equipped with a parachute and a propulsion device in an undeployed position during freefall according to one aspect of the present embodiments. FIG. 5A shows the back view 200A for the propulsion device during freefall (i.e., undeployed position) and FIG. 5B shows the front view 200C for the propulsion device during freefall.

FIG. 6A shows the upper attachment points 620 (chest configuration) to the parachute harness in one nonlimiting example. In some embodiments, a B12 fastener or quick release fastener may be used that is attached via one or more webbing to a single point release system. In the illustrated embodiment, a 3-ring release system is shown. In some embodiments, when a parachutist pulls a release handle, it pulls one or more of cables 610 that are coated with metal cables. The cables 610 are routed through a series of loops or rings, thereby enabling release of the attachment point from the device.

FIG. 6B shows the lower attachment points 640 (chest configuration) to the parachute harness in one nonlimiting example. In some embodiments, the lower attachment points may be outfitted with the single-point release system as described above, which could all attach to the same handle. However, in some examples, the lower attachment points 640 may not utilize the single-point release system allowing the parachutists to detach manually prior to releasing the upper attachment points. The lower attachment points run an adjustable piece of webbing to a quick release system in some embodiments. It is appreciated that the bead structure 630 may serve as a handle in aiding the parachutist to detach the quick-ejector or quick release fastener.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and the various modifications that are suited to the particular use contemplated.

What is claimed is:

1. A device comprising:
a harness system configured to be attached to a parachute harness of a parachute;
a propulsion system connected to the harness system, wherein the propulsion system is configured to be off when undeployed and during freefall, and wherein the propulsion system is configured to deploy during canopy flight stage to generate thrust for a parachutist of the parachute;
a circuitry configured to control power generation by the propulsion system to control the thrust; and
a power source configured to power the circuitry and the propulsion system.

2. The device of claim 1, wherein the harness system comprises a fastener for attaching to the parachute harness via at least one webbing to a single point release system.

3. The device of claim 2, wherein the single point release system comprises a release handle connected to a cable that once pulled releases the propulsion system, the circuitry and the power source.

4. The device of claim 1, wherein the propulsion system comprises at least a motor to generate thrust.

5. The device of claim 4, wherein the motor is a fan electric motor.

6. The device of claim 4, wherein the propulsion system includes a deployment lever, wherein the at least the motor is mechanically moved from a first position to a second position during the canopy flight stage and in response to the deployment lever being moved.

7. The device of claim 6, wherein the at least the motor is mechanically moved from the second position to the first position during the canopy flight stage for landing.

8. The device of claim 6 further comprising a deployment arm that is configured to move the at least the motor from the first position to the second position.

9. The device of claim 8, wherein the deployment arm is a folding arm.

10. The device of claim 1, wherein the propulsion system includes a left portion and a right portion wherein the left portion and the right portion are symmetrical when the propulsion system is deployed during the canopy flight.

11. The device of claim 10, wherein the circuit is configured to control thrust by controlling the left portion and the right portion.

12. The device of claim 1, wherein the propulsion system is programmable to provide a preprogrammed lateral distance to the freefall once deployed at a given altitude.

13. The device of claim 1 further comprising a lever activation arm configured to deploy the propulsion system during canopy flight stage in response to a user moving the lever activation arm.

14. The device of claim 1 further comprising a control device configured to control operation of the propulsion system and the circuitry in response to a user manipulation.

15. An apparatus comprising:
a harness configured to be attached to a parachutist;
a parachute configured to be deployed by the parachutist during freefall to enter a canopy flight stage; and
a range extension apparatus comprising:
a range extension harness system configured to be attached to the harness of the parachute; and
a propulsion system comprising a motor, a circuitry, and a power source,
wherein the circuitry is configured to control operation of the motor,
wherein the motor is configured to generate thrust,
wherein the power source is configured to power the circuitry and the motor,
wherein the motor is configured to generate no thrust when undeployed and during freefall, and wherein the motor is configured to generate thrust for the parachute once it is deployed during canopy flight stage.

16. The apparatus of claim 15, wherein the range extension harness system comprises a fastener for attaching to the harness via at least one webbing to a single point release system, and wherein the single point release system comprises a release handle connected to a cable that once pulled releases the range extension apparatus.

17. The apparatus of claim 15, wherein the motor is a fan electric motor.

18. The apparatus of claim 15, wherein the range extension apparatus includes a deployment lever, wherein the motor is mechanically moved from a first position to a second position during the canopy flight stage and in response to the deployment lever being moved, and wherein the motor is mechanically moved from the second position to the first position during the canopy flight stage for landing.

19. The apparatus of claim 18 further comprising a folding arm that is configured to move the motor from the first position to the second position.

20. The apparatus of claim 15, wherein the motor includes a left portion and a right portion wherein the left portion and the right portion are symmetrical when the range extension apparatus system is deployed during the canopy flight, and wherein the circuit is configured to control thrust by controlling the left portion and the right portion.

21. The apparatus of claim 15, wherein the range extension apparatus is programmable to provide a preprogrammed lateral distance to the freefall once deployed at a given altitude.

22. The apparatus of claim 15 further comprising a control device configured to control operation of the range extension apparatus in response to a user manipulation.
